(19) United States
(12) Patent Application Publication
(10) Pub. No.: US 2004/0203304 A1
(43) Pub. Date: Oct. 14, 2004

(54) Rubberized fabric and pneumatic tire comprising said rubberized fabric

(76) Inventors: Celine Almonacil, Verderio Inferiore (IT); Guido Riva, Milano (IT); Alessandro Volpi, Milano (IT)

Correspondence Address: Finnegan Henderson Farabow, Garrett & Dunner, 1300 I Street NW, Washington, DC, 20005, US

(21) Appl. No.: 10/477,215

(22) PCT Filed: May 21, 2002
(86) PCT No.: PCT/EP02/05537

Related U.S. Application Data
(60) Provisional application No. 60/294,209, filed on May 31, 2001.

(30) Foreign Application Priority Data
May 25, 2001 (EP) 01112687.7

(51) Int. Cl. B32B 27/12

(52) U.S. Cl. 442/59; 152/526; 152/451; 442/394

(57) ABSTRACT

A rubberized fabric includes at least one substantially metal-free non-woven web having a plurality of fibers. At least some of these fibers are bonded together. The fibers can be substantially oriented in one or more directions. The fabric also includes at least one elastomeric material at least partially covering the at least one non-woven web. The fabric can be incorporated in various locations in a pneumatic tire, such as in a belt structure. Additionally, a pneumatic tire may include one or more elongated rubberized structures including one or more layers of a non-woven web having a plurality of non-metallic fibers substantially oriented in one or more directions relative to the at least one surface.

The present invention relates to non-woven fabrics. While the invention is directed to a wide range of applications, it is especially suited for use in the tire industry, and will be particularly described in that connection.

Generally, processes for manufacturing non-woven fabrics can be grouped into four general categories: (1) textile related; (2) paper related; (3) extrusion-polymer-processing related; and (4) hybrid combinations.

Extrusion-polymer-processing-related processes include at least spunbond, meltblown, and porous film systems. The fabrics produced by these systems are generically referred to as polymer-laid non-wovens, and include at least spunbond, meltblown, and textured-film or apertured-film non-wovens. Typically, the structure of these fabrics demonstrates a good strength-to-weight ratio (spunbond non-wovens), a high surface-area-to-weight ratio (meltblown non-wovens), or high property uniformities-per-unit-weight (textured-film non-wovens).

The basic structural units of a non-woven fabric are the fibers. As a result, the fibers included in a non-woven fabric determine many of the fabric's properties.

As used herein, the term “fiber” means any unit of natural or synthetic matter characterized by a high length-to-width ratio. Typical fibers used in non-woven fabrics include cotton, glass, nylon, polyester, polypropylene, rayon, and wood pulp.

Organic fibers, such as polyester, polypropylene, and rayon, are formed from high-molecular-weight polymers.

Individual fibers typically comprise one type of polymer. Some fiber structures comprise more than one type of polymer such as, for example, bicomponent or multicomponent fibers. The configuration of said bicomponent fibers can be, for example: a sheath/core arrangement, wherein one polymer is surrounded by another; a side-by-side arrangement; a pie arrangement; an “islands-in-the-sea” arrangement.

One skilled in the art understands the extension of such bicomponent arrangements to multicomponent arrangements.

The fibers in a non-woven fabric may be bonded together to improve structural integrity of said fabric. Such bonding may include at least one or more of: chemical bonding, hydro-entanglement bonding, mechanical bonding, solvent bonding, thermal bonding, or ultrasonic bonding.

Chemical bonding, using one or more chemicals, is one of the most common bonding method. Known chemicals for bonding include: natural resins and glues as well as synthetic chemicals such as acrylics, ethylene/vinyl chloride (“EVCl”), poly(vinyl acetate) (“PVAc”), poly(vinyl chloride) (“PVC”), styrenated acrylic, styrene/butadiene rubber (“SBR”), vinyl acetate (“VAC”), vinyl/acrylic acetate, and ethylene/vinyl acetate (“EVA”).

Thermal bonding is, generally, a process of binding by applying heat to a web of thermoplastic fibers or a web impregnated with meltable powders or thermoplastic fibers. Typically, thermal bonding is accomplished through a combination of heating, flowing, and cooling. The heating may be accomplished, for example, by using conduction, convection, radiation, sonic impact.

Hydro-entanglement bonding includes at least the entanglement of fibers due to fluid forces.

Mechanical bonding includes at least the bonding of fibers due to physical contact between the fibers.

Solvent bonding includes at least the bonding of fibers due to the use of a chemical solvent.

Ultrasonic bonding includes at least the bonding of fibers due to the use of ultrasonic energy.

Processes for manufacturing non-woven fabrics typically include fiber formation, web formation, and web consolidation phases. In at least spunbond and meltblown extrusion-polymer-processing-related processes, these phases generally are performed as an integrated, single unit operation.

Fiber formation typically includes at least the extrusion of one or more continuous polymer fibers.

Web formation typically includes at least the pattern layering of the one or more polymer fibers on one or more conveying screens (spunbond non-wovens), or the collection on one or more conveying screens or shapes of the one or more polymer fibers (meltblown non-wovens). Web consolidation typically includes at least the interlocking of preferably arranged fiber assemblies.

During web formation, spunbond fibers may be pattern layered by: (1) oscillating groups of fibers assembled as curtains; (2) oscillating a deflecting plate, and/or (3) spreading fibers by air. In each case the web is assembled on a moving screen and fiber orientation in the web depends on the relative rates of lateral fiber movement and conveying speed. Spunbond fibers typically display average diameters between about 7 microns and about 30 microns. The nature of meltblown non-woven webs may be varied by adjustment of the blowing air temperature, velocity, and direction. These parameters affect individual fiber length, diameter, and physical properties. Other important factors include orifice geometry and the distance between the die assembly and the one or more conveying screens or shapes. Meltblown fibers typically display average diameters smaller than about 10 microns.

Most often, the one or more conveying screens or shapes are held under vacuum. The weight of non-woven webs can be varied by changing conveyor speed or adding additional extrusion positions. Layered products can be produced on multiple extruder lines by extruding different polymers at various extruder positions. Non-woven web weights typically range from about 5 grams-per-square-meter to about 1,000 grams-per-square-meter. Web widths typically range from less than 1 meter to about 5 meters.

Both web consolidation and non-woven web bonding processes typically include at least the interlocking of preferably arranged fiber assemblies by one or more of chemical bonding, thermal bonding, hydro-entanglement bonding, mechanical bonding, solvent bonding, ultrasonic bonding, or similar methods. The degree of such bonding is a factor in determining fabric integrity, strength, porosity, flexibility, softness, density, and other properties.

Spunbond non-wovens typically are composed of continuous fibers. Factors in the production of spunbond non-wovens include, for example, the control of four simultaneous operations: fiber extrusion, drawing, lay down/web formation, and web bonding. Fiber extrusion and drawing are elements of man-made fiber spinning and constitute the “spun” phase of the process, while lay down/web formation and web bonding are the web formation and consolidation or “bonding” phase, hence the generic term “spunbond.”

A typical spunbond process transforms one or more polymers directly to a web by extruding fibers, stretching the fibers in bundles or groups to ensure a desired molecular alignment, pattern layering the fibers on one or more conveying screens, and bonding the fibers together by one or more of chemical bonding, thermal bonding, hydro-entanglement bonding, mechanical bonding, solvent bonding, ultrasonic bonding, or similar methods.

Different methods of achieving spunbond non-wovens have been developed as commercial operations. These methods differ essentially in the method of passing the one or more polymers through one or more spinnerets, separating the fibers at an extruder head, orienting the fibers, collecting the fibers on the one or more conveying screens, and bonding the fibers together.

Although any man-made fiber spinning process can be used, melt spinning and flash spinning are the principal technologies employed in commercial spunbond non-woven systems.

In a typical melt-spinning process, thermoplastic polymer resins in solid chip form are heated to a liquid state and forced through small orifices into cool air where they again solidify as continuous fiber bundles or groups, according to the shape of the orifice. The fiber bundles or groups are then mechanically stretched by a factor of two to five times to ensure a desired molecular alignment which provides strength, extensibility and other physical properties.

In a typical flash-spinning process, a dilute solution of a polymer resin in a solvent is heated and pressurized. Extrusion of the hot, pressurized solution into atmospheric pressure forms a high-velocity stream, from which the solvent flashes off, yielding a fiber bundle. Electrostatic charge is applied to separate the fibers. A deflector baffle facilitates web formation.

Other spunbond manufacturing parameters include extrusion variables such as spinneret design, geometry control of the fiber stretching, fiber arrangement in the web, bonding method, and finishing process (if any). Spinneret size affects fiber diameter which, in turn, influences at least fiber size, fabric coverage, and throughput.

Stretching affects molecular alignment, which influences fabric strength, modulus, elongation, toughness, fiber diameter, and other physical properties. Fiber arrangement directly affects fabric uniformity and mechanical isotropy. The bonding method influences fabric thickness, strength, porosity, and other characteristics. Finishing processes can influence surface texture; moisture affinity; electrical and frictional properties.

Fiber and polymer type directly influence properties such as mass, density, temperature stability, chemical resistance, radiation stability, and ease of coloration.

Meltblown non-wovens, like most spunbond non-wovens, are typically manufactured directly from thermoplastic resins. A polymer resin in chip form is heated to a liquid state, and, as the liquid-state polymer passes through extrusion orifices, it is injected with hot, sonic-velocity air at about 250° C. to about 500° C. The hot, sonic-velocity air effectively stretches the liquid-state polymer and solidifies it into a random array of discontinuous, fine-diameter fibers. The fibers are then separated from the air stream as a randomly entangled web and compressed between heated rollers.

The combination of fine-diameter fibers, random entanglement, and compression yields a structure with large surface area and small pore size. However, the fibers in meltblown non-wovens generally lack strength, in part because the fibers do not undergo controlled stretching to obtain uniform molecular alignment and its resulting strength characteristics.

Similar to spunbond non-wovens, meltblown non-woven properties are dependent on manufacturing practices and polymer types. Meltblown non-woven processing parameters include at least die design, air characteristics, resin flow, placement of the one or more conveying screens or shapes, and web handling. The quality of meltblown non-wovens can be improved by delivering more uniform webs, carefully controlling fiber dimensions, eliminating small polymer lumps (also known as “shot”), and minimizing large fiber bundles (also known as “roping”).

Die design features include at least overall die geometry, consideration of the type of resin to be used, air-orifice geometry and placement, the number of individual nozzles per die, and the number of dies per production line. The pressure of the hot, sonic-velocity air affects fiber size. Generally, higher pressure yield finer fibers, from about 1 micron to about 5 microns, and lower pressure yields coarser fibers, from about 20 microns to about 50 microns. Other factors affecting the physical properties of meltblown non-wovens include at least resin throughput (also known as “pump rate”), the distance from the die assembly to the one or more conveying screens or shapes, and fiber stretching.

Additional information regarding non-wovens can be found, for example, at the Internet web site of the Nonwovens Group of Miller Freeman, Inc., at http://www.nonwovens.com/.

Pneumatic tires are generally made of rubber matrix composites (typically uniaxial or generally anisotropic) provided with reinforcing elements.

Therefore, the elementary unit, which is used in tire manufacturing processes, is usually a rubberized ply provided with uniaxial reinforcing elements.

The components forming said elementary unit come from at least three different processing lines: the rubber compound production process, the production process of the reinforcing elements and the assembling operation of the rubber compound with the reinforcing element.

Usually, the reinforcing element to be used is a steelcord or a textile fabric. Both of them are produced by multi-step processes involving a plurality of specific basic operations.

For instance, the production process of a textile fabric generally includes the following steps: fiber production, fiber twisting, fiber cabling, fabric weaving, fabric dipping and fabric treating.

In the case a textile fabric is used, the elementary unit, i.e. the rubberized ply, is successively produced by rubberizing said textile fabric, for example by calendering.

From the foregoing, the Applicant has perceived that producing an elementary unit as defined above implies multi-step processes which are inevitably time-consuming and costly.

Furthermore, due to the complexity of said production processes and to the plurality of parameters involved, the elementary unit quality depends on a great number of factors and can not be simply achieved;

For instance a critical parameter is certainly the weight of the elementary unit which depends not only on the weight of the reinforcing material, but also on the volume of rubber which is necessary to completely embed the reinforcing material in order to obtain a composite of a given strength and/or modulus.

Moreover, since not only uniaxial composites but also anisotropic composites are usually employed in the tyre manufacturing processes, further production steps are inevitably needed.

In fact, the required anisotropy of said composites is obtained by cutting the elementary unit, as defined above, at different angles, with respect to the inclination of the reinforcing elements, and successively by piling up the cut elementary units according to suitable configurations well-known to the skilled in the art.

U.S. Pat. No. 3,895,665, issued Jul. 22, 1975, to Heling et al., has proposed to construct a reinforcement mat for rubber tires comprising non-woven metal staple fibers entangled with one another in the form of a cohesive mass, said mat having at least a portion of the pores thereof filled with rubber. The mat of non-woven metal fibers may also contain natural and/or synthetic fibers in an amount between. 5% and 70%-by-weight. Preferably, the non-woven metal fibers are bent or crimped.

U.S. Pat. No. 4,871,004, issued Oct. 3, 1989, to Brown et al., has proposed to reinforce elastomers with aramid in the form of short, discontinuous, fibrillated fibers. The fibrillated fibers are composed of a trunk portion and numerous fibrils extending outwardly from the trunk. The fibrillated fibers are oriented in the elastomers and the reinforced elastomers are suitable for use in pneumatic tires.

From the foregoing, the Applicant has perceived the need to remarkably simplify the production of uniaxial composites and, above all, of the anisotropic composites in the tyre industry.

Therefore, the present invention is directed to a rubberized fabric, a pneumatic tire comprising the rubberized fabric, and a pneumatic tire comprising one or more elongated rubberized structures.

As used herein, the term “elongated structure” means a three-dimensional structure with one dimension of substantially greater length than the other two dimensions. Non-limiting examples of said elongated rubberized structures include at least a strip, a ribbon, a narrow sheet, a cylinder, and similar structures.

Additional features and advantages of the present invention will be set forth in part in the description which follows, and in part will be apparent from the description, or may be learned by practice of the invention. The objectives and other advantages of the present invention will be realized and attained by means of the elements and combinations particularly pointed out in the appended claims.

According to the present invention, one embodiment is directed to a rubberized fabric comprising at least one substantially metal-free non-woven web having a plurality of fibers, wherein at least some of the fibers are bonded together, and at least one elastomeric material at least partially impregnates the at least one non-woven web.

In a second embodiment, the present invention is directed to a rubberized fabric comprising at least one non-woven web having a plurality of fibers, wherein the fibers are substantially oriented in one direction, and wherein at least some of the fibers are bonded together, and at least one elastomeric material at least partially impregnates the at least one non-woven web. Preferably, the non-woven web is substantially metal-free. Even more preferably, said fibers are substantially oriented in at least two directions.

In a third embodiment, the present invention is directed to a pneumatic tire comprising a rubberized fabric including at least one substantially metal-free non-woven web having a plurality of fibers, wherein at least some of the fibers are bonded together, and at least one elastomeric material at least partially covering the at least one non-woven web.

In a fourth embodiment, the present invention is directed to a pneumatic tire, comprising at least one carcass ply, a belt structure at least partially overlapping the at least one carcass ply, and a tread band at least partially overlapping the belt structure, wherein the belt structure comprises a rubberized fabric including at least one substantially metal-free non-woven web having a plurality of fibers, wherein at least some of the fibers are bonded together, and at least one elastomeric material at least partially impregnates the at least one non-woven web.

In a fifth embodiment, the present invention is directed to a pneumatic tire, comprising at least one carcass ply, a belt structure at least partially overlapping the at least one carcass ply, and a tread band at least partially overlapping the belt structure, wherein the belt structure comprises a rubberized fabric including at least one non-woven web having a plurality of fibers, wherein the fibers are substantially oriented in one direction, and wherein at least some of the fibers are bonded together, and at least one elastomeric material at least partially impregnates the at least one non-woven web. Preferably, the non-woven web is substantially metal-free. Even more preferably, said fibers are substantially oriented in at least two directions.

In an sixth embodiment, the present invention is directed to a pneumatic tire comprising one or more elongated rubberized structures having at least one surface, said one or more structures further comprising one or more layers of a non-woven web having a plurality of fibers substantially oriented in one or more directions relative to the at least one surface, wherein at least some of the fibers are bonded together, and at least one elastomeric material at least partially impregnates the one or more layers.

Other than in the operating examples, or where otherwise indicated, all numbers expressing quantities of measurements, ingredients, reaction conditions, and so forth used in the specification and claims are to be understood as being modified in all instances by the term “about.” Accordingly, unless indicated to the contrary, the numerical parameters set forth in the following specification and claims are approximations that may vary depending upon the desired properties sought to be obtained by the present invention. At the very least, and not as an attempt to limit the application of the doctrine of equivalents to the scope of the claims, each numerical parameter should be construed in light of the number of significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

It is to be understood that both the foregoing general description and the following detailed description are exemplary, explanatory, and intended to provide further explanation of the invention as claimed. These descriptions are not restrictive of the invention as claimed.

The accompanying drawings, which are incorporated in and constitute a part of this specification, are included to provide a further understanding of the invention. These drawings illustrate some embodiments of the invention and, together with the description, serve to explain the objectives, advantages, and principles of the invention. In the drawings:

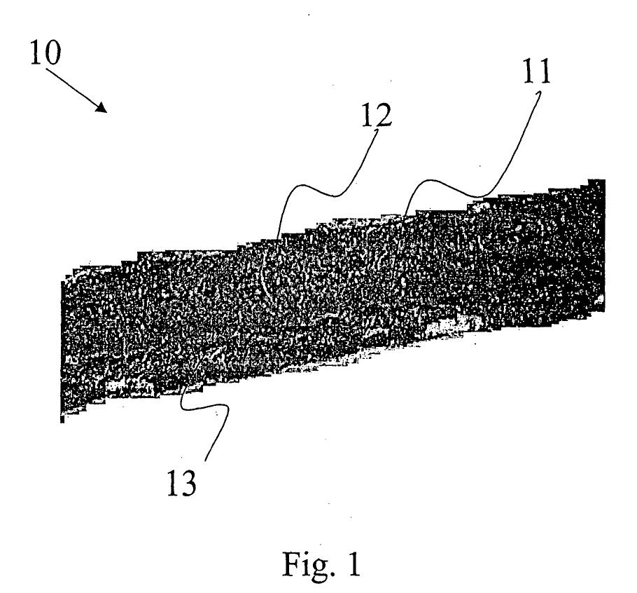

FIG. 1 is a cross section of a rubberized fabric according to one embodiment of the present invention showing a non-woven web interposed between two layers of elastomeric material, said elastomeric material impregnating said non-woven web so that some of the fibers of said non-woven web can reach the external surfaces of said rubberized fabric;

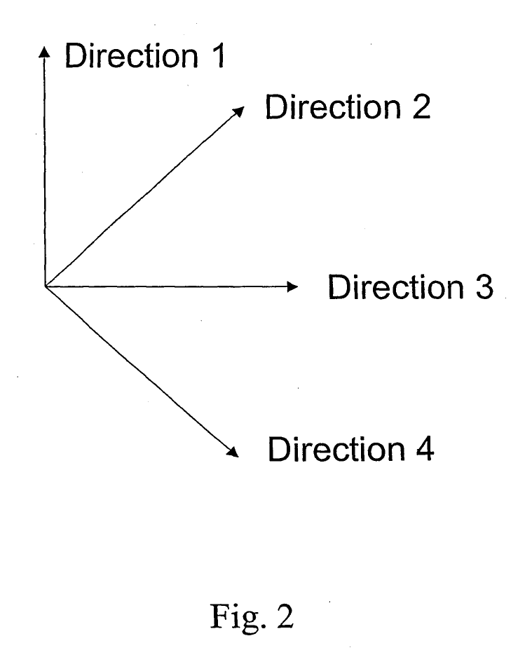

FIG. 2 is a top view of a system of coordinates showing the four directions of testing a non-woven web sample;

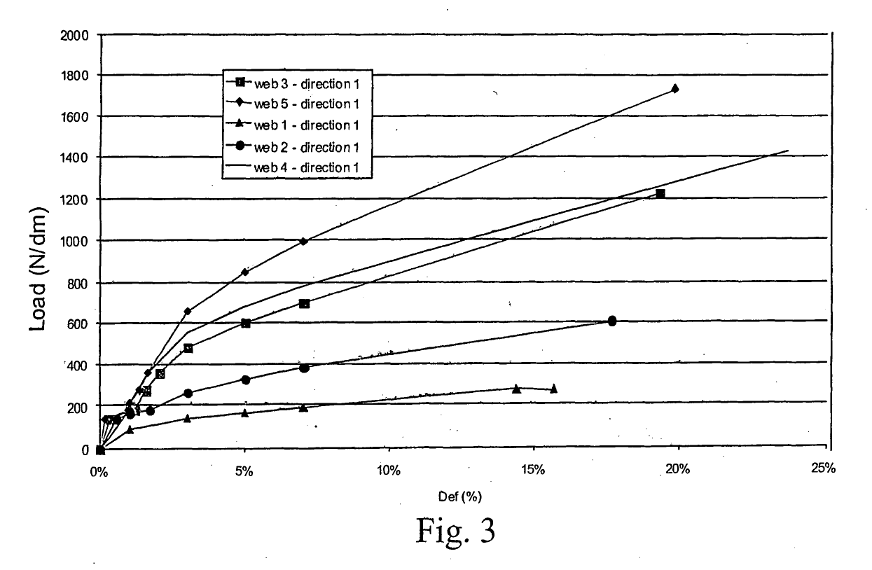

FIG. 3 is a load-versus-deformation graph for five non-woven web samples according to the present invention and tested in one machine direction;

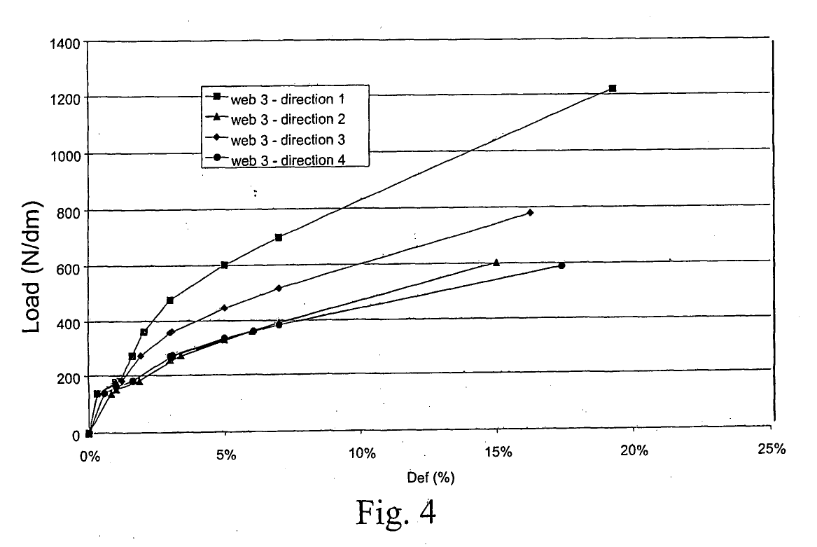

FIG. 4 is a load-versus-deformation graph for one non-woven web sample in four machine directions;

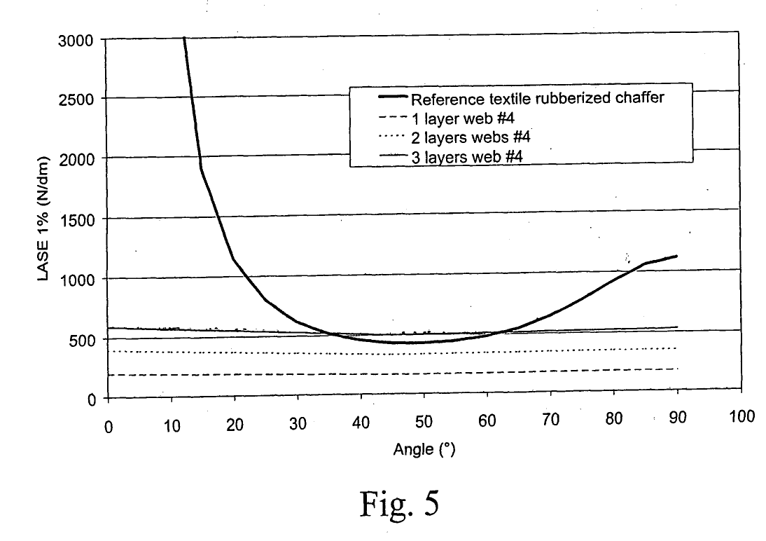

FIG. 5 is a load-at-specific-elongation versus cord-angle graph of one non-woven web according to the present invention; and

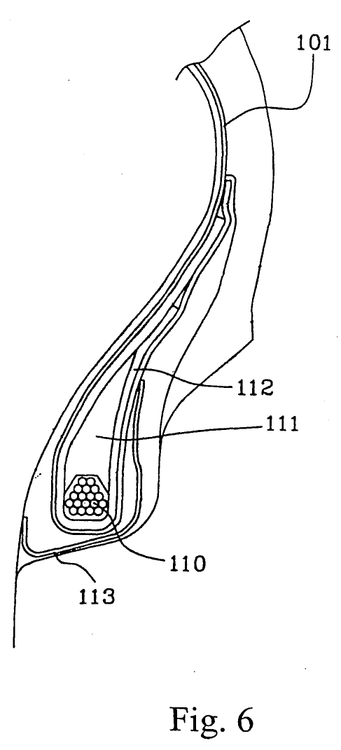

FIG. 6 is a partial cross-section of a pneumatic tire wherein conventional chafer and flipper elements are shown.

Reference will now be made in detail to the present preferred embodiments of the invention, examples of which are illustrated in the accompanying drawings. Wherever possible, the same reference numbers will be used throughout the drawings to refer to the same or like parts.

In a first embodiment, a rubberized fabric comprises at least one substantially metal-free non-woven web having a plurality of fibers (at least some of the fibers being bonded together) and at least one elastomeric material at least partially impregnating the at least one non-woven web.

As used herein, the term “fabric” means a three-dimensional material having one dimension generally smaller than the other two.

As used herein, the term “substantially metal-free” means that an amount less than about 2.5%-by-weight of metal in any form is present.

As used herein, the term “web” means an assembly including multiple polymer fibers.

As used herein, the term “non-woven web” means a web having a structure of fibers, but not in the type of strictly regular pattern typically associated with a weaved fabric.

As used herein, the term “bonded together” means connected to at least one other like component at one or more locations by one or more of chemical bonding, thermal bonding, hydro-entanglement bonding, mechanical bonding, solvent bonding, ultrasonic bonding, or similar methods.

As used herein, the term “impregnating” means in contact with or joined to an outer surface of the non-woven web.

As shown in FIG. 1, rubberized fabric 10 comprises one substantially metal-free non-woven web 11 having a plurality of fibers. Said fibers may comprise one or more types of polymer fibers, the molecular weight of said one or more types of polymers generally influencing the strength of the non-woven web 11 and of the rubberized fabric 10.

The orientation of the plurality of fibers may be random or controlled. Random orientation generally yields substantially isotropic properties for the non-woven web and the rubberized fabric. Controlled orientation generally yields substantially anisotropic properties for the non-woven web and the rubberized fabric.

The fiber orientation can be expressed in terms of a fiber orientation distribution function (“ODF”). The ODF graphs provide a method of visually analyzing the isotropic or anisotropic nature of a non-woven web and/or of the rubberized fabric. Methods for experimentally determining the ODF include at least: (1) direct measurement, for example, mechanically measuring properties such as breaking load in various directions; (2) indirect measurement, for example, measuring optical diffraction characteristics of a laser beam or other light source through a non-woven web, and (3) analysis of composite sections in different directions.

Preferably, said fibers comprise: aramid fibers, nylon 6 fibers, nylon 66 fibers, polyester fibers, poly(ethylene terephthalate) fibers, poly(ethylene naphthalate) fibers, polyketone fibers, poly(vinyl alcohol) fibers, rayon fibers, glass fibers, carbon fibers or combinations thereof.

Said fibers may take many forms and/or structures and may be spunbond, meltblown, or a combination of spunbond and meltblown.

At least some of the fibers are bonded together and may be bonded together by one or more of chemical bonding, thermal bonding, hydro-entanglement bonding, mechanical bonding, solvent bonding, ultrasonic bonding, or other similar methods.

The rubberized fabric according to the present invention also includes at least one elastomeric material which at least partially covers the at least one substantially metal-free non-woven web.

In details, as shown in the embodiment of FIG. 1, rubberized fabric 10 includes a first elastomeric material 12 and a second elastomeric material 13.

Additionally, rubberized fabric 10 may include only one elastomeric material 12 or 13.

The at least one elastomeric material 12, 13 may include, for example, one or more typical elastomeric materials used in the tire industry, such as, for example, acrylonitrile-butadiene rubber (“NBR”), butyl rubbers (“IIR”), chloroprene rubber (“CR”), ethylene-propylene rubber (“EPM” or “EPDM”), epoxy natural rubber (“EPR”), halogenated butyl rubber (“XIIR”), natural rubber (“NR”), polybutadiene rubber (“BR”), polyisoprene rubber (“IR”), styrene-butadiene rubber (“SBR”), or combinations thereof. One skilled in the art will recognize the wide variety of such elastomeric materials.

Furthermore, the at least one elastomeric material may take a variety of forms. For example, the at least one elastomeric material may comprise an elastomeric sheet that can, in turn, be calendered with the at least one non-woven web.

Additionally, the at least one elastomeric material can be spread onto the at least one non-woven web in liquid form. Such spreading may be accomplished by immersion of the at least one non-woven web in a liquid elastomeric material, followed by wiping off the excess liquid. This immersion/wiping method allows the production of thin rubberized fabrics and/or elongated rubberized structures. Many other possible forms of the elastomeric material are known to those of skill in the art.

Furthermore, the at least one elastomeric material may include, for example, one or more typical fillers used in the tire industry, such as, for example: accelerators; activators; anti-aging agents; anti-fatigue agents; antioxidants; plasticizers; process and extender oils; reinforcing fillers, such as bentonite, calcium carbonate, carbon black, chalk, kaolin, silica, silicates, talc, and titanium dioxide; retarders; softeners; stabilizers; vulcanizing agents, such as silanes, stearic acid, sulfur, and zinc oxide; adhesion promoters; or combinations thereof. One skilled in the art will recognize the wide variety of such fillers.

Moreover, the at least one elastomeric material may be reinforced, for example, with aramid in the form of short, discontinuous, fibrillated fibers. Such aramid fibers are commercially available under names such as Kevlar® (a registered trademark of Du Pont) and Twaron® (a registered trademark of Akzo Nobel) and can be predisperded in a generic elastomeric material.

If the at least one elastomeric material comprises such aramid fibers, said fibers may preferably be preoriented in one or more directions, for example by means of a calendering operation, to improve performance characteristics, such as strength.

First elastomeric material 12 and/or second elastomeric material 13 may be in contact with an outer surface of the at least one non-woven web 11. Said contact may only occur in selected locations of said outer surface or may occur more frequently, such as across said entire outer surface of the at least one non-woven web 11.

Impregnation of first elastomeric material 12 and/or second elastomeric material 13 into gaps in the at least one non-woven web 11 generally improves the mechanical resistance of rubberized fabric 10.

Alternatively, first elastomeric material 12 and/or second elastomeric material 13 may be joined to an outer surface of the at least one non-woven web 11 for example by using one or more adhesive, such as resorcinol-formaldehyde latex (“RFL”), in case in combination with an epoxy resin.

Said adhesive may be applied to the at least one non-woven web 11, first elastomeric material 12 and/or second elastomeric material 13 by any known method, such as, for example, by dipping, spraying, or spreading.

Rubberized fabric 10 may be in the form of a relatively flat sheet and may comprise only one non-woven web 11 or more than one non-woven web 11.

For instance, where rubberized fabric 10 is in the form of a relatively flat sheet and comprises only one non-woven web 11, the at least one elastomeric material may at least partially cover the non-woven web 11 on one side or on both sides of said sheet.

In a preferred embodiment, the rubberized fabric is in the form of a relatively flat sheet and comprises only one substantially metal-free non-woven web.

In a further embodiment, the rubberized fabric is in the form of a relatively flat sheet and comprises more than one substantially metal-free non-woven web. Preferably, the elastomeric materials and the substantially metal-free non-woven webs form successive layers in the rubberized fabric. The layers may strictly alternate between elastomeric material and substantially metal-free non-woven web, or there may be consecutive layers of either the elastomeric materials and/or the substantially metal-free non-woven webs. The elastomeric materials may be in contact with and/or joined to the substantially metal-free non-woven webs.

Rubberized fabric 10 may comprise more than one substantially metal-free non-woven web 11 having a plurality of fibers. These more than one substantially metal-free non-woven webs may be arranged, for example, in physical contact with each other in a side-by-side, layered, or other arrangement. They may also be arranged, for example, in a side-by-side, layered, or other arrangement, but not in physical contact with each other. Additionally, the plurality of fibers of any of these more than one substantially metal-free non-woven webs 11 may comprise different types of fibers than the plurality of fibers of any other of these more than one substantially metal-free non-woven webs 11.

Rubberized fabric 10 may comprise more than one elastomeric material at least partially covering the at least one substantially metal-free non-woven web 11. These more than one elastomeric materials may be arranged, for example, in physical contact with each other in a side-by-side, layered, or other arrangement. They may also be arranged, for example, in a side-by-side, layered, or other arrangement, but not in physical contact with each other. Additionally, any one of these more than one elastomeric materials may include one or more different polymers or other constituents than any other of these more than one elastomeric materials.

The thickness of rubberized fabric 10 is preferably between about 0.05 mm and about 5 mm, more preferably between about 0.1 mm and about 2 mm, and most preferably between about 0.2 mm and about 1 mm.

The thickness of the at least one substantially metal-free non-woven web 11 is preferably between about 0.05 mm and about 5 mm, more preferably between about 0.08 mm and about 1 mm, and most preferably between about 0.1 mm and about 0.5 mm.

In a further embodiment, the rubberized fabric according to the present invention comprises at least one non-woven web having a plurality of fibers, wherein the fibers are substantially oriented in one direction, and wherein at least some of the fibers are bonded together, and at least one elastomeric material at least partially covering the at least one non-woven web.

As used herein, the term “substantially oriented in one direction” means typically following a similar, not necessarily linear, path, and preferably aligned in one general direction, and/or having an ODF generally displaying two maxima with about a 180° difference in angle between the two maxima.

According to said further embodiment, the at least one non-woven web of the invention may contain more than about 2.5%-by-weight of metal in any form. However, preferably said at least one non-woven web is substantially metal-free.

In the case the rubberized fabric comprises more than one non-woven web, the fibers of different non-woven webs may be substantially oriented in different directions, e.g. the fibers of one non-woven web may be oriented in a first direction while the fibers of a distinct non-woven web may be oriented in a second direction different from said first direction.

Furthermore, the fibers of said at least one non-woven web can be substantially oriented in at least two directions. As used herein, the term “substantially oriented in at least two directions” means typically following two or more similar, not necessarily linear, paths, and preferably aligned in two or more general directions, and/or having an ODF generally displaying more than two maxima. In this case, the fibers belonging to distinct non-woven webs may be substantially oriented in different directions, e.g. the fibers of one non-woven web may be oriented in two directions while the fibers of a distinct non-woven web may be oriented in three directions which are different from said two directions.

Once again, according to said embodiment the thickness of the rubberized fabric is preferably between about 0.05 mm and about 5 mm, more preferably between about 0.1 mm and about 2 mm, and most preferably between about 0.2 mm and about 1 mm, and the thickness of the at least one non-woven web is preferably between about 0.05 mm and about 5 mm, more preferably between about 0.08 mm and about 1 mm, and most preferably between about 0.1 mm and about 0.5 mm.

According to a further embodiment, a pneumatic tire comprises a rubberized fabric including at least one substantially metal-free non-woven web having a plurality of fibers (at least some of the fibers being bonded together) and at least one elastomeric material at least partially covering the at least one non-woven web.

The rubberized fabric may be, for example, one of the previously described forms of embodiment.

Said rubberized fabric may be used in many parts of a tire, whether the tire is used for two-wheeled vehicles, such as typical motorcycles, four-wheeled vehicles, such as typical automobiles, or other vehicles.

Non-limiting examples include using the rubberized fabric as, in place of, or together with: a breaker layer; an essentially 0° belt layer; a radial carcass ply; a bias belted carcass ply; a pulp-reinforced rubber sheet; a chafer; a flipper; a bead wrap; an under-tread; or other similar uses.

Other non-limiting examples include using the rubberized fabric as, in place of, or together with: a separator located between two or more carcass plies; between two or more belt layers; between one or more carcass plies and one or more belt layers; or other similar uses.

As used herein, the term “carcass ply” includes, at least, radial-ply, bias-ply and other types of carcass plies.

As used herein, the term “belt structure” includes at least belts, breakers, separators between belt strips or layers, separators between two or more carcass plies, separators between one or more carcass plies and one or more belt strips or layers, and similar structures.

As used herein, the term “tread band” includes at least a structure, typically made of rubber or similar material, designed to contact a road or similar surface.

As used herein, the term “flipper” relates to one or more additional, preferably strip-like, inserts which are wound in a loop around the annular reinforcing structures, i.e. the bead core and the bead filler of a tire. In FIG. 6 is shown the bead core 110, the bead filler 111, the carcass ply 101 and the flipper 112. The flipper has the function to increase the lateral stability and the load-bearing capacity of the tire, above all during flat travel.

As used herein, the term “chafer” relates to one or more rubber-coated strips comprising textile or metallic cords, said chafer being located axially external to the carcass ply and around the outer portion of the bead core and the bead filler. In FIG. 6 the chafer is indicated with reference sign 113.

As mentioned above, the chafer can be obtained by superimposing and partially overlapping at least two rubber-coated strips. As used herein, the term “overlapping” means that two overlapped elements are not butt spliced, but joined together for at least small portions thereof.

By using a plurality of rubber-coated strips to constitute the chafer, thanks to the rubberized fabric of the present invention it is possible to modify mechanical properties, e.g. the rigidity, of the chafer by increasing or decreasing the number of superimposed strips as well as the overlapping portions thereof.

Once again, according to said further embodiment the thickness of the rubberized fabric is preferably between about 0.05 mm and about 5 mm, more preferably between about 0.1 mm and about 2 mm, and most preferably between about 0.2 mm and about 1 mm, and the thickness of the at least one non-woven web is preferably between about 0.05 mm and about 5 mm, more preferably between about 0.08 mm and about 1 mm, and most preferably between about 0.1 mm and about 0.5 mm.

The present invention will be described further by reference to the following examples that are merely illustrative of the broad scope of the invention and are not intended to be limiting in any way.

### EXAMPLES 1-5

Five non-woven webs were produced in which the fibers were spunbond PET fibers and at least some of the fibers were bonded together by thermal bonding.

The non-woven webs were produced in the form of flat sheets, from which testing samples were obtained and tested without any further treatment, i.e. they were free from adhesive and rubber.

Measured properties of said non-woven webs included: weight (g/m²), thickness (mm), breaking load in each direction 1 to 4 (N/dm), breaking elongation in each direction 1 to 4 (%), load at a specific extension of one percent (LASE 1%) in direction 1 (N/dm), load at a specific extension of one percent per unit weight (i.e., LASE 1%/Weight) in direction 1 ((N/dm)/(g/m²)), and tenacity in direction 1 ((N/dm)/(g/m²)). As used herein, the term “tenacity” means breaking load per unit weight.

FIG. 2 is a top view of a coordinate system used for measuring the above-listed properties of the testing samples of said non-woven webs.

Said coordinate system defines direction 1 as a machine direction, direction 2 as 450 from direction 1, direction 3 as 90° from direction 1 (i.e., direction 3 is a cross-machine direction), and direction 4 as 135° from direction 1.

The weight of said webs was measured by using an analytical scale with a 0.1 mg precision. The thickness was measured by using a thickness gage satisfying ASTM standard D 1777. The breaking load in each direction 1 to 4, the breaking elongation in each direction 1 to 4, and LASE 1% in direction 1 were measured by using a Zwick BZ010 tensile tester with a load cell of 10 kN. The LASE 1%/Weight in direction 1 was calculated based upon the LASE 1% in direction 1 and upon the weight. The tenacity in direction 1 was calculated based upon the breaking load and the weight.

Table 1 summarizes the values of said measured properties.

TABLE 1

| Measured Property | Web 1 | Web 2 | Web 3 | Web 4 | Web 5 |
|---|---|---|---|---|---|
| Weight (g/m²) | 42.02 | 78.86 | 111.54 | 149.30 | 205.38 |
| Thickness (mm) | 0.13 | 0.23 | 0.28 | 0.41 | 0.42 |
| Breaking Load, dir. 1 | 272 | 605 | 1,219 | 1,422 | 1,728 |
| (N/dm) | | | | | |
| Breaking Load, dir. 2 | 119 | 525 | 601 | 1,155 | 1,406 |
| (N/dm) | | | | | |
| Breaking Load, dir. 3 | 134 | 406 | 778 | 1,103 | 1,280 |
| (N/dm) | | | | | |
| Breaking Load, dir. 4 | 209 | 473 | 587 | 1,045 | 1,268 |
| (N/dm) | | | | | |
| Breaking Elongation, dir. 1 (%) | 15.6 | 17.6 | 19.2 | 20.7 | 19.8 |
| Breaking Elongation, dir. 2 (%) | 7.6 | 18.0 | 15.0 | 19.2 | 15.5 |
| Breaking Elongation, dir. 3 (%) | 10.0 | 14.2 | 16.2 | 22.3 | 18.5 |
| Breaking Elongation, dir. 4 (%) | 12.3 | 14.4 | 17.3 | 23.6 | 18.1 |
| LASE 1%, dir. 1 | 90 | 159 | 175 | 196 | 186 |
| (N/dm) | | | | | |
| LASE 1%/Weight, dir. 1 | 2.16 | 2.02 | 1.57 | 1.32 | 0.91 |
| ((N/dm)/(g/m²)) | | | | | |
| Tenacity, dir. 1 | 6.48 | 7.67 | 10.93 | 9.53 | 8.41 |
| ((N/dm)/(g/m²)) | | | | | |

For said five non-woven webs (Examples 1-5) load versus deformation in direction 1 ((N/dm)/%), which is represented in a graphical format in FIG. 3, was measured too.

Moreover, a further measured property of non-woven web 3 was load versus deformation in directions 1 to 4 ((N/dm)/%) which is represented in a graphical format in FIG. 4.

### EXAMPLE 6

In order to evaluate the maximum adhesive pick-up achievable in an industrial process, a laboratory procedure was used on testing samples obtained from non-woven web 3.

The adhesive used included a 3% of epoxy resin solution and a 26% of RFL solution.

Five approximately circular-disk testing samples were cut from the non-woven web 3 by using a cutting die with a diameter of 112.84 mm+/−0.5 mm (corresponding to a sample area of about 100.00 cm²+/−0.88 cm²). Thus, the surface area of one face of each of the disk samples was approximately one decimeter square (dm²).

The disk samples were placed on a clean dish of known weight. Then, the disk samples and the dish were weighed together for a first time.

Next, each disk sample was taken from the dish by using tweezers, dipped for about 30 seconds in the epoxy resin solution at room temperature, laid on absorbing paper to remove the excess of epoxy resin solution, and then deposited on a grill.

The grill and the five disk samples were then inserted into an oven at about 160° C. for approximately 2.5 minutes to heat treat the disk samples while the disk samples were not under tension.

Following this first heat treatment, the disk samples were returned to the clean dish. Then, the disk samples and the dish were weighed together for a second time.

Next, each disk sample was taken from the dish by using tweezers, dipped for about 30 seconds in the RFL solution at room temperature, laid on absorbing paper to remove the excess of the RFL solution, and then deposited on the grill.

The grill and the five disk samples were then inserted into an oven at about 230° C. for approximately 2.5 minutes to heat treat the disk samples while the disk samples were not under tension.

Following said second heat treatment, the disk samples were returned to the clean dish. Then, the disk samples and the dish were weighed together for a third time.

Calculated values include: the total weight of the five disk samples at each of the three weighings; the percent weight increase after the epoxy resin solution dip; the percent weight increase after the RFL solution dip; and the total percent weight increase which is calculated by the following formula:

Percent weight increase=(weight after dip−weight before dip)/(weight before dip),

where the “weight after dip” is the total weight of the five disk samples after a specific dip and the “weight before dip” is the total weight of the five disk samples before that same dip.

The percent weight increase of each of the five disk samples appeared to be substantially similar. Table 2 summarizes said calculated values.

TABLE 2

| | |
|---|---|
| Weight of Five Disks-Initial | 6.24 |
| (g) | |
| Weight of Five Disks-After First Dip | 6.33 |
| (g) | |
| Weight of Five Disks-After Second Dip | 7.99 |
| (g) | |
| Weight Increase-After First Dip | 1.4 |
| (%) | |
| Weight Increase-After Second Dip | 26.7 |
| (%) | |
| Weight Increase-Total | 28.1 |
| (%) | |

The measured properties indicated in Table 2 illustrate that the disk samples of non-woven web 3 demonstrate a significant adhesive pickup (also known as “dip pickup”), which is represented by the total weight increase value which is higher than adhesive pickup values of conventional industrial fibers (generally comprised between 3 and 15%).

Although by changing the operative conditions, such as by using a different method of applying one or more adhesives or by using different adhesives, would likely yield different results for adhesive pickup, the maximum achievable adhesive pickup is still high.

### EXAMPLES 7-12

Six testing samples were prepared from non-woven web 3: three of them were treated with a 3% epoxy resin solution and a 26% RFL solution (by using the same procedure described with reference to Example 6), while the remaining three were not treated.

Each testing sample was sandwiched between two rubber sheets, each of said sheets being approximately 0.5 mm in thickness, to form six rubberized fabrics. The rubber used was a compound based on 100% of natural rubber and containing bonding agents for polymeric fibers.

The obtained rubberized fabrics were manually rolled with a solid cylindrical roller so as to remove the trapped air and vulcanized.

In order to measure the adhesion between the rubber sheets and the testing sample of each rubberized fabric, peeling tests (also called 2-ply strip test) were performed.

In details, a peeling test to determine the load (N) under which at least one of the two rubber sheets would peel away from the associated non-woven web was conducted on each of the six rubberized fabrics.

Peeling was observed in the three not-treated rubberized fabrics at average mean load of 50 N. In each of the six cases, peeling occurred without rupture of either rubberized fabric.

Peeling was observed in the three treated rubberized fabrics at an average mean load of 85 N. In one case the rubberized fabric ruptured under load and the test was continued on the remaining half of the treated rubberized fabric.

### EXAMPLES 13-16

The rubberized fabric of the present invention was tested on passenger-car tires having size 195/55 R15.

In details, four tires (1-4) were provided with a 0° belt layer made of the rubberized fabric according to the present invention, while a comparative tire (5) was provided with a conventional 0° belt layer made of a rubberized fabric including nylon cords.

Table 3 summarizes the measures carried out on said tires.

TABLE 3

| | | | | | Tire 5 |
|---|---|---|---|---|---|
| | | | | | (comparative) |
| | Tire 1 | Tire 2 | Tire 3 | Tire 4 | Nylon |
| | 7 layers | 4 layers | 4 layers | 3 layers | 1400/1 |
| | of Web 1 | of Web 2 | of Web 3 | of Web 4 | F85 |
| Cord Weight (g/m²) | 125 | 316 | 444 | 447 | 294 |
| Rubber Weight (g/m²) | 88 | 95 | 124 | 134 | 605 |
| Total Fabric Weight (g/m²) | 382 | 411 | 577 | 581 | 730 |
| Area (m²/tire) | 0.53 | 0.53 | 0.53 | 0.53 | 0.53 |
| Weight (g/tire) | 203 | 218 | 306 | 308 | 387 |
| Thickness (mm) | 0.91 | 0.92 | 1.12 | 1.23 | 0.65 |
| LASE 1% (N/dm) | 637 | 636 | 700 | 591 | 637.5 |
| Weight Reduction (g/tire) | 184 | 169 | 81 | 79 | — |

In order to carry out said calculations, it was assumed that the rubber used in the rubberized fabric was the 30% by weight of the non-woven web weight.

Table 3 shows that, by using the rubberized fabric of the invention instead of a coventional 0° belt layer, a relevant weight reduction can be obtained, fact which has a positive effect on the tire rolling resistance.

Furthermore, the weight reduction is very important also with respect to the tire integrity which is improved at high speeds since the centrifugal forces are linearly dependent upon the mass, i.e. the weight.

### EXAMPLES 17-20

Similarly to Examples 13-17, the rubberized fabric of the present invention was tested on passenger-car tires having size 205/50 R15.

In details, four tires (6-9) provided with a 0° belt layer made of the rubberized fabric according to the present invention and one comparative tire (10) provided with a conventional 0° belt layer made of a rubberized fabric including nylon cords were tested.

Table 4 summerizes the measures carried out on said tires.

TABLE 4

| | | | | | Tire 10 |
|---|---|---|---|---|---|
| | | | | | (comparative) |
| | Tire 6 | Tire 7 | Tire 8 | Tire 9 | Nylon |
| | 7 layers | 4 layers | 4 layers | 3 layers | 1400/1 |
| | of Web 1 | of Web 2 | of Web 3 | of Web 4 | F85 |
| Cord Weight (g/m²) | 294 | 316 | 444 | 447 | 125 |
| Rubber Weight (g/m²) | 88 | 95 | 124 | 134 | 605 |
| Total Fabric Weight (g/m²) | 382 | 411 | 577 | 581 | 730 |
| Area (m²/tire) | 0.67 | 0.67 | 0.67 | 0.67 | 0.67 |
| Weight (g/tire) | 256 | 275 | 386 | 389 | 491 |
| Thickness (mm) | 0.91 | 0.92 | 1.12 | 1.23 | 0.65 |
| LASE 1% (N/dm) | 637 | 636 | 700 | 591 | 637.5 |
| Weight Reduction (g/tire) | 235 | 216 | 105 | 102 | |

In order to carry out said calculations, it was assumed that the rubber used in the rubberized fabric was the 30% by weight of the non-woven web weight.

The same advantages mentioned above with reference to Examples 13-16 can be obtained by the rubberized fabrics of Examples 17-20.

### EXAMPLES 21 AND 22

The rubberized fabric of the present invention was tested on two motorcycle tires having size 120/70 ZR17 and 180/55 ZR17 respectively.

In details, two comparative tires (12 and 14) were provided with a pulp-reinforced sheet between the carcass ply and the 0° belt layer, while two tires (11 and 13) were provided with one rubberized fabric according to the present invention replacing said pulp-reinforced sheet. If necessary, more than one layer can be used.

Table 5 summarizes the measures carried out on said tires.

The rubber weight indicated in table 5 for the comparative tires already includes the weight of the pulp reinforcement, therefore there is no indication of a cord weight for the comparative tires.

TABLE 5

| | 120/70 ZR17 | | 180/55 ZR17 | |
|---|---|---|---|---|
| | Tire 11 | Tire 12 | Tire 13 | Tire 14 |
| | 1 layer | Com- | 1 layer | Com- |
| | of Web 1 | parative | of Web 1 | parative |
| Cord Weight (g/m²) | 42 | | 42 | |
| Rubber Weight (g/m²) | 13 | 400 | 13 | 400 |
| Total Fabric Weight (g/m²) | 55 | 400 | 55 | 400 |
| Area (m²/tire) | 0.22 | 0.22 | 0.34 | 0.34 |
| Weight (g/tire) | 12 | 90 | 18 | 139 |
| Thickness (mm) | 0.13 | 0.35 | 0.13 | 0.35 |
| Weight Reduction (g/tire) | 29 | | 116 | |

In order to carry out said calculations, it was assumed that the rubber used in the rubberized fabric was the 30% by weight of the non-woven web weight.

Once again table 5 shows that, by using the rubberized fabric of the present invention, a relevant weight reduction can be obtained, fact which remarkably improves tire performances, above all in the case of two-wheeled vehicles.

### EXAMPLES 23-25

The rubberized fabric of the present invention was tested on passenger-car tires having size 275/40 R18.

In details, three tires (15-17) were provided with a chafer made from the rubberized fabric according to the present invention, while a comparative tire (18) was provided with a conventional rubberized textile chafer.

Table 6 summarizes the measures carried out on said tires.

TABLE 6

| | Tire 15 | Tire 16 | Tire 17 | |
|---|---|---|---|---|
| | 1 layer | 2 layers | 3 layers | Tire 18 |
| | of Web 4 | of Web 4 | of Web 4 | Comparative |
| Cord Weight | 111 | 222 | 333 | 300 |
| (g/m²) | | | | |
| Rubber Weight | 33 | 67 | 100 | 810 |
| (g/m²) | | | | |
| Total Fabric Weight | 144 | 289 | 433 | 1,110 |
| (g/m²) | | | | |
| Area | 0.26 | 0.26 | 0.26 | 0.26 |
| (m²/tire) | | | | |
| Weight | 38 | 76 | 114 | 292 |
| (g/tire) | | | | |
| Thickness | 0.41 | 0.82 | 1.23 | 1 |
| (mm) | | | | |
| Weight Reduction | 254 | 216 | 178 | — |
| (g/tire) | | | | |

The mechanical properties of the rubberized textile chafer as a function of the angle between a load and the textile cords in the rubberized textile chafer were calculated by using Halpin-Tsai equations.

These equations are described in S. K. Clark, Mechanics of Pneumatic Tires, U.S. Department of Transportation (1981), the contents of which is relied upon and incorporated herein by reference. The parameters used in the Halpin-Tsai equations for said calculations include: the tensile modulus of the cords (E_{c}=14,560 MPa), the Poisson's ratio of the cord (v_{c}=0.5), the volume fraction of the cord in the calendered ply (V_{c}=0.29), the tensile modulus of the rubber compound (Eᵣ=5 MPa), the Poisson's ratio of the rubber compound (vᵣ=0.5), and the shear modulus of the cords (G_{c}=0.49 MPa).

Said values are used to calculate the longitudinal Young's modulus (eq.3.2, Clark p. 131), the major Poisson's ratio (eq. 3.3, Clark p. 131), the transverse Young's modulus (eq. 3.4a, Clark p. 132), the in-plane shear modulus (eq. 3.5a, Clark p. 132). Said values are then used to calculate the modulus in off-axis directions (eq. 3.11, Clark p. 139).

The result of said calculations yields a graph of LASE 1% as a function of the angle between a load and the textile cords in the rubberized textile chafer.

Analogously, with reference to the tires including a chafer made of the rubberized fabric according to the invention, a separate set of calculations yields graphs of LASE 1% as a function of the angle between a load and said rubberized fabric.

FIG. 5 compares said graphs referred to, respectively: a chafer of the invention made of 1 layer of web 4; a chafer of the invention made of 2 layers of web 4; a chafer of the invention made of 3 layers of web 4; a conventional textile rubberized chafer.

FIG. 5 shows that, for angles of approximately 45°, the value of LASE 1% for the rubberized textile chafer is approximately the same as that of a chafer including 2 or 3 layers of the rubberized fabric of the present invention. Therefore, by replacing the rubberized textile chafer with the rubberized fabric of the present invention it is possible to achieve an effective weight reduction as shown also by the measured values reported in Table 6.

1. A rubberized fabric comprising at least one substantially metal-free non-woven web having a plurality of fibers, wherein at least some of the fibers are bonded together and at least one elastomeric material at least partially covers said non-woven web, said fibers being substantially oriented in at least two directions lying on the plane of the rubberized fabric.

2. The rubberized fabric of claim 1, wherein the at least some of the fibers are bonded together by one or more of chemical bonding, thermal bonding, hydro-entanglement bonding, mechanical bonding, solvent bonding, or ultrasonic bonding.

3. The rubberized fabric of claim 1, wherein at least one of the plurality of fibers are polymer fibers.

4. The rubberized fabric of claim 1, wherein at least one of the plurality of fibers are nylon 6 fibers, nylon 66 fibers, poly(ethylene terephthalate) fibers, poly(ethylene naphthalate) fibers, polyketone fibers, poly(vinyl alcohol) fibers, or combinations thereof.

5. The rubberized fabric of claim 1, wherein a thickness of the rubberized fabric is between about 0.05 mm and about 5 mm.

6. The rubberized fabric of claim 5, wherein the thickness of the rubberized fabric is between about 0.1 mm and about 2 mm.

7. The rubberized fabric of claim 6, wherein the thickness of the rubberized fabric is between about 0.2 mm and about 1 mm.

8. The rubberized fabric of claim 1, wherein a thickness of the at least one non-woven web is between about 0.05 mm and about 5 mm.

9. The rubberized fabric of claim 8, wherein the thickness of the at least one non-woven web is between about 0.08 mm and about 1 mm.

10. The rubberized fabric of claim 9, wherein the thickness of the at least one non-woven web is between about 0.1 mm and about 0.5 mm.

11. A pneumatic tire comprising a rubberized fabric including at least one substantially metal-free non-woven web having a plurality of fibers, wherein at least some of the fibers are bonded together and at least one elastomeric material at least partially covers said non-woven web, said fibers being substantially oriented in at least two directions lying on the plane of the rubberized fabric.

12. The pneumatic tire of claim 11, wherein the rubberized fabric is used as, in place of, or together with: a 0° belt layer; a radial carcass ply; a bias belted carcass ply; a pulp-reinforced rubber sheet; a chafer; a flipper; a bead wrap; an under-tread reinforcement.

13. The pneumatic tire of claim 12, wherein the rubberized fabric is used as, in place of, or together with: a separator located between two or more carcass plies; between two or more belt layers; between one or more carcass plies and one or more belt layers.

14. A pneumatic tire, comprising:
at least one carcass ply;
a belt structure at least partially overlapping the at least one carcass ply; and
a tread band at least partially overlapping the belt structure;
wherein the belt structure comprises a rubberized fabric including at least one non-woven web having a plurality of fibers, wherein at least some of the fibers are bonded together-, and at least one elastomeric material at least partially covers said non-woven web, said fibers being substantially oriented in at least two directions lying on the plane of the rubberized fabric.

15. The pneumatic tire of claim 14, wherein said non-woven web is substantially metal free.

16. A pneumatic tire comprising one or more elongated rubberized structures having at least one surface, the one or more structures further comprising one or more layers of a non-woven web having a plurality of fibers substantially oriented in at least two directions relative to the at least one surface, wherein at least some of the fibers are bonded together, and at least one elastomeric material at least partially covering the one or more layers.

17. The pneumatic tire of claim 16, wherein at least one of the one or more elongated rubberized structures is used as, in place of, or together with: an essentially 0° belt; a radial-ply belt; a bias-ply belt; a pulp-reinforced sheet; a chafer; a flipper; a bead wrap; or an under-tread reinforcement.

18. The pneumatic tire of claim 17, wherein at least one of the one or more elongated structures is used as, in place of, or together with: a separator located between two or more carcass plies; between two or more belt plies; or between one or more carcass plies and one or more belt plies.
